(19) United States
(12) Patent Application Publication
(10) Pub. No.: US 2024/0135940 A1
(43) Pub. Date: Apr. 25, 2024

(54) METHODS, APPARATUS AND SYSTEMS FOR LEVEL ALIGNMENT FOR JOINT OBJECT CODING

(71) Applicant: DOLBY INTERNATIONAL AB, Dublin (IE)

(72) Inventors: Leif Jonas SAMUELSSON, Sundbyberg (SE); Heiko PURNHAGEN, Sundbyberg (SE); Lars VILLEMOES, Järfälla (SE)

(73) Assignee: DOLBY INTERNATIONAL AB, Dublin (IE)

(21) Appl. No.: 18/547,050

(22) PCT Filed: Feb. 9, 2022
(86) PCT No.: PCT/EP2022/053082

§ 371 Date: Aug. 18, 2023

Related U.S. Application Data
(60) Provisional application No. 63/153,719, filed on Feb. 25, 2021.

(51) Int. Cl. G10L 19/008; H04S 3/00

(52) U.S. Cl. CPC G10L 19/008; H04S 3/008; H04S 2400/11; H04S 2420/03

(57) ABSTRACT

A method for modifying object reconstruction information, comprising obtaining a set of N spatial audio objects, each spatial audio object including an audio signal and spatial metadata, obtaining an audio presentation representing the N spatial audio objects, obtaining object reconstruction information configured to reconstruct the N spatial audio objects from the audio presentation, applying the reconstruction information to the audio presentation to form a set of N reconstructed spatial audio objects, using a first rendering configuration, rendering the N spatial audio objects to obtain a first rendered presentation, and rendering the N reconstructed spatial audio objects to obtain a second rendered presentation, and modifying the reconstruction information based on a difference between the first rendered presentation and the second rendered presentation, thereby forming modified reconstruction information.

### CROSS-REFERENCE TO RELATED APPLICATIONS

This application claims priority of the following priority applications: U.S. provisional application 63/153,719 (reference: D21011USP1), filed 25 Feb. 2021, which is hereby incorporated by reference.

### TECHNICAL FIELD

The present disclosure relates to audio object processing, and in particular encoding and decoding of audio objects.

### BACKGROUND

The object-based representation of immersive audio content is a powerful approach that combines intuitive content creation with optimal reproduction over a large range of playback configurations using suitable rendering systems. Object-based audio is, for example, a key element of the Dolby Atmos system. An audio object comprises the actual audio signal and associated metadata, such as the position of the object. In order to deliver object-based audio to consumer entertainment devices, an efficient representation is required to enable broadcast, streaming, download, or similar transmission scenarios. For this purpose, various processing of the objects is done, such as spatial coding and object encoding.

One specific encoding approach is the joint object coding (JOC) approach, as discussed in H. Purnhagen, T. Hirvonen, L. Villemoes, J. Samuelsson, J. Klejsa, “Immersive Audio Delivery Using Joint Object Coding”, in AES 140th Convention, Paris, FR, May 2016. An example of this is the Dolby Digital Plus (DD+) JOC system in “Backwards-compatible object audio carriage using Enhanced AC-3”, ETSI TS 103 420 V1.1.1 (2016-07). Joint Object Coding can be used in combination with Spatial Coding as a pre-processor to reduce the number of objects that have to be transmitted, as discussed in J. Breebaart, G. Cengarle, L. Lu, T. Mateos, H. Purnhagen, N. Tsingos, “Spatial Coding of Complex Object-Based Program Material,” J. Audio Eng. Soc., vol. 67, no. 7/8, pp. 486-497, July 2019.

In a JOC encoder, the objects are rendered to downmix signals, e.g. a 5.1. surround representation, and JOC parameters are computed that enable the JOC decoder to reconstruct the objects from the downmix signals. The JOC encoder transmits the downmix signals, the JOC parameters, and the object metadata to the JOC decoder. Typically, the object-based content comprises a higher number of objects than the number of downmix signals, thus enabling more efficient transmission. Furthermore, the downmix signals themselves can be transmitted efficiently using perceptual audio coding systems such as DD+. Typically, the JOC parameters control how an object is reconstructed as a linear combination of the downmix signals, and the JOC parameters are time- and frequency-varying and transmitted for each time/frequency (T/F) tile. A common initial approach to compute the JOC parameters for a given object in a given T/F tile is to achieve the best approximation in a minimum mean square error (MMSE) sense. However, if exact reconstruction is not possible, the approximation error implies that the reconstructed object has a lower level (measured as energy or variance). In order to achieve a perceptually more appropriate approximation, it is advantageous to boost (i.e., gain) the reconstructed object so that it has the same level (i.e., energy) as the original object, and this boost can be achieved by changing the JOC parameters accordingly.

However, this approach does not ensure that the complete covariance matrix of the reconstructed objects matches the covariance matrix of the original objects. It only ensures that the diagonal elements of the covariance matrix (i.e., the object energies) are correctly reinstated. Often, an increased correlation between reconstructed objects can be observed, which can result in level build-up effects when the reconstructed objects are rendered for playback, such as over a 7.1.4 loudspeaker system. This build-up is observed when comparing to the rendering of the original objects and can manifest itself for example as an increased perceived loudness of objects in the content that are affected by it.

### GENERAL DISCLOSURE OF THE INVENTION

It is an objective of the present invention to improve processing of audio objects, including avoiding level errors like level loss and level build-up in object encoding.

According to a first aspect of the present invention, this and other objectives are achieved by a method for modifying object reconstruction information, comprising obtaining a set of N spatial audio objects, each spatial audio object including an audio signal and spatial metadata, obtaining an audio presentation representing the N spatial audio objects, obtaining object reconstruction information configured to reconstruct the N spatial audio objects from the audio presentation, applying the reconstruction information to the audio presentation to form a set of N reconstructed spatial audio objects, using a first rendering configuration, rendering the N spatial audio objects to obtain a first rendered presentation, and rendering the N reconstructed spatial audio objects to obtain a second rendered presentation, and modifying the reconstruction information based on a difference between the first rendered presentation and the second rendered presentation, thereby forming modified reconstruction information.

By analyzing (comparing) rendered presentations of the original objects and the processed objects, respectively, the reconstruction information can be modified to thereby make a rendering of the reconstructed objects to even better correspond to a rendering of the original objects.

In some embodiments, the method according to the first aspect is used for audio object encoding. In this case, the audio presentation is a set of M audio signals which are encoded into a set of encoded audio signals; and the encoded audio signals and the modified reconstruction information are combined into a bitstream for transmission. In a more specific example, the M audio signals represent a downmix of the audio signals of the N spatial audio objects, the object reconstruction information is a set of reconstruction parameters configured to reconstruct the N spatial audio objects from the M audio signals, and the modified reconstruction information is a set of modified reconstruction parameters.

In these embodiments, the decoding process may remain unchanged, but will use the modified reconstruction information conveyed in the bitstream. This will mitigate e.g. level errors that would otherwise occur if the unmodified reconstruction parameters had been used on the decoder side.

The method may further comprise, using a second rendering configuration, rendering the N spatial audio objects to generate a third rendered presentation and rendering the N reconstructed spatial audio objects to generate a fourth rendered presentation, determining a second set of object specific modification gains associated with the second rendering configuration; and including, in the encoded bitstream, one of 1) both the first and second set of object specific modification gains, and 2) a ratio between the first and second set of object specific modification gains.

With this approach, the encoded bitstream will include information to allow a receiving decoder to obtain modified reconstructed objects associated with one of multiple rendering configurations, e.g. 5.1.2 or 7.1.4.

According to a second aspect of the invention, this and other objectives are achieved by a method for decoding spatial audio objects in a bitstream, comprising: decoding the bitstream to obtain a set of M audio channels, a set of reconstruction parameters, configured to reconstruct a set of N spatial audio objects from the M audio signals, the reconstruction parameters associated with a first rendering configuration, and modification gains associated with a second rendering configuration. The method further includes determining a playback rendering configuration, in response to determining the playback rendering configuration, applying the modification gains to the reconstruction parameters to obtain alternative reconstruction parameters, and applying the alternative reconstruction parameters to the M audio signals to obtain a set of N reconstructed spatial audio objects.

For example, if the playback rendering configuration is determined to correspond to the second rendering configuration, the modification gains can be applied so that the alternative reconstruction parameters are associated with the second rendering configuration.

In one example, the modification gains include a first set of object specific modification gains associated with the first rendering configuration and a second set of object specific modification gains associated with the second rendering configuration, and the step of applying the modification gains to the reconstruction parameters includes applying the first set of modification gains to remove the reconstruction parameter's association with the first rendering configuration, and applying the second set of modification gains to associate the reconstruction parameters to the second rendering configuration.

In another example, the modification gains include a set of ratios, h(n)/h₂(n), between a first object specific modification gains, h(n), associated with the first rendering configuration and a second object specific modification gain, h₂(n), associated with the second rendering configuration.

A further aspect of the invention relates to an encoder comprising a downmix renderer configured to receive a set of N spatial audio objects and to generate a set of M audio signals representing the N spatial audio objects, an object encoder for obtaining object reconstruction information configured to reconstruct the N spatial audio objects from the M audio signals, an object decoder for applying the reconstruction information to the M audio signals to form a set of N reconstructed spatial audio objects, a renderer configured to, using a first rendering configuration, render the N spatial audio objects to obtain a first rendered presentation and render the N reconstructed spatial audio objects to obtain a second rendered presentation, a modifier for modifying the reconstruction information based on a difference between the first rendered presentation and the second rendered presentation, thereby forming modified reconstruction information, an encoder configured to encode the M audio signals into a set of encoded audio signals, and a multiplexer for combining the encoded audio signals and the modified reconstruction information into a bitstream for transmission.

Yet another aspect of the invention relates to an decoder comprising a decoder for decoding a bitstream including a set of M audio channels, a set of reconstruction parameters, c_{mod}(n, m), configured to reconstruct a set of N spatial audio objects from the M audio signals, the reconstruction parameters associated with a first rendering configuration, and modification gains associated with a second rendering configuration. The decoder includes an alternating unit configured to, in response to a determined playback rendering configuration, apply the modification gains to the reconstruction parameters, c_{mod}(n, m), to obtain alternative reconstruction parameters c_{mod2}(n, m), and an object decoder for applying the alternative reconstruction parameters c_{mod2}(n, m) to the M audio signals to obtain a set of N reconstructed spatial audio objects.

Further aspects include computer program products comprising computer program code portions configured to perform the methods according to the first and second aspects when executed on a computer processor.

### BRIEF DESCRIPTION OF THE DRAWINGS

The present invention will be described in more detail with reference to the appended drawings, showing currently preferred embodiments of the invention.

FIG. 1 illustrates a first implementation of the present invention.

FIGS. 2a-b illustrate an encoding and decoding system, including a further implementation of the present invention.

FIGS. 3A-B are flow charts of the encoding/decoding process according to an implementation of the present invention.

FIGS. 4a-b show encoding and decoding systems including a yet another implementation of the present invention.

FIGS. 5a-b show encoding and decoding systems including a yet another implementation of the present invention.

### DETAILED DESCRIPTION

A person skilled in the art will understand, that although not explicitly mentioned in the following description, all signals are typically divided in time (frames) and frequency (bands) and the processing thus takes place in time-frequency tiles. For ease of notation, the time and frequency dependencies have been excluded in the description.

Further, in the following disclosure, an “object”, an “audio object” or a “spatial audio object” should be understood as including an audio signal and associated metadata including spatial rendering information.

### Overview

### Preliminaries

A rendering configuration is a set of rules that, given metadata for the spatial audio objects like for example object positions, yields rendering gains g(k, n) that describe how much an object signal S(n) contributes to rendering signal L(k). The set of rendering signals L(k), k=1, . . . , K is called a rendered representation of the set of objects S(n), n=1, . . . , N, or in short, a rendition of the set of objects. The rendition of the original set of objects, S(n), n=1, . . . , N, is called the original rendition, and the rendition of the processed set of objects is called the processed rendition. Likewise, the rendition of the modified (level aligned) set of objects is called the modified rendition.

Calculating the original rendition L(k), k=1, . . . , K can be expressed based on:

L(k)=Σₙ₌₁^{N}g(k,n)S(n), k=1, . . . , K (1)

which can be written as

$$[ \begin{matrix}L ( 1 ) \\ ⋮ \\ L ( K )\end{matrix} ] = [ \begin{matrix}g ( 1 , 1 ) & … & g ( 1 , N ) \\ ⋮ & & ⋮ \\ g ( K , 1 ) & … & g ( k , N )\end{matrix} ] [ \begin{matrix}S ( 1 ) \\ ⋮ \\ S ( N )\end{matrix} ] \qquad ( 2 )$$

or, more compactly

L=GS (3)

Likewise, given the processed objects S_{P}(n), calculating the processed rendition L_{P}(k), k=1, . . . , K can be expressed

L_{P}(k)=Σₙ₌₁^{N}g(k,n)S_{P}(n), k=1, . . . , K (4)

or, more compactly

L_{P}=GS_{P} (5)

### Level Alignment

The goal of level alignment is: given the original and processed objects, calculate modified objects such that the rendered representation calculated from the modified processed objects (the modified rendition) exhibits rendering signal levels that are as close as possible to the levels of the rendered representation from the original objects (the original rendition).

To enable level alignment while maintaining the properties of the objects as much as possible, modification gains h(n) are applied to the objects. The modified objects S_{M}(n) can be calculated based on

S_{M}(n)=h(n)S_{P}(n), n=1, . . . , N (6)

and the associated modified rendition

L_{M}=GS_{M} (7)

In the following, methods to compute the modification gains h(n) are presented. Energies of, and cross-correlations between signals are computed as part of these methods. The energy of an object can be computed based on

∥S(n)∥²=Σₜ₌₁^{T}S(n,t)S̅(̅n̅,̅t̅)̅ (8)

where t is indexing across all the complex valued signal samples in the time-frequency tile and the bar denotes the complex conjugate. Similarly, the complex-valued cross-correlation between two objects can be computed based on

[symbol]

S(m),S(n) [symbol] =Σₜ₌₁^{T}S(m,t)S̅(̅n̅,̅t̅)̅ (9)

and similarly for the energies ∥L(k)∥² of rendered signals.

### MMSE Methods

First, an MMSE method is presented where the mean squared error

MSE=Σₖ₌₁^{K}∥L_{M}(k)−L(k)∥² (10)

is minimized. The gains h(n) that minimize the MSE satisfy

Σₙ₌₁^{N}h(n)Re{ [symbol] S_{P}(m),S_{P}(n) [symbol] }Σₖ₌₁^{K}g(k,n)g(k,m)=Σₖ₌₁^{K}g(k,m)Re{ [symbol] S_{P}(m),L(k) [symbol] },m=1, . . . , N (11)

which is a system of N linear equations with N unknowns h(n), n=1, . . . , N that can readily be solved with computationally efficient numerical methods. A feature of the MMSE approach is that the total energy of the modified rendition cannot exceed the total energy of the original rendition. On the other hand, especially when the processed objects differ significantly from the original objects, a significant loss of energy can result. Moreover, this can happen even in the case where the energies of the processed rendition are already equal to the energies of the original rendition.

A modified MMSE method that avoids the latter phenomenon is obtained by replacing the prediction target L(k) with f(k)L_{P}(k) where f(k) are rendering signal alignment gains aimed at obtaining the desired output levels.

### A Gain-Distribution Method

In another method, the signal energies ∥L(k)∥² of the original rendition, and the signal energies ∥L_{P}(k)∥² of the processed rendition respectively are computed, and the rendering signal alignment gains f(k) are computed based on

$$f ( k ) = \sqrt{\frac{{‖ L ( k ) ‖}^{2}}{{‖ {L}_{P} ( k ) ‖}^{2}}} , k = 1 , … , K \qquad ( 12 )$$

From the rendering signal alignment gains, the object modification gains can be computed based on

$$h ( n ) = {\sum }_{k = 1}^{K} f ( k ) \frac{{g}^{2} ( k , n )}{{\sum }_{l = 1}^{K} {g}^{2} ( l , n )} , n = 1 , … , N \qquad ( 13 )$$

In other words, the modification gains h(n) are computed as a weighted sum of the alignment gains f(k) where the sum of the weights over all k for any given n is one. This can be described as a distribution of the alignment gains according to the weights (the weights being determined from the rendering gains) to obtain the modification gains. In the case where the processed objects are uncorrelated, these gains are exactly those obtained by the modified MMSE method described in the previous section.

An alternative example to compute the modification gains is this formula

$$h ( n ) = \sqrt{{\sum }_{k = 1}^{K} {f ( k )}^{2} \frac{{g}^{2} ( k , n )}{{\sum }_{l = 1}^{K} {g}^{2} ( l , n )}} , n = 1 , … , N \qquad ( 14 )$$

It can be seen that a deviation in rendering signal k, i.e. f(k)≠1, will affect objects in proportion to the objects' contribution to that rendering signal. Furthermore, both of these formulas achieve the desired effect ∥L_{P}(k)∥²=∥L(k)∥² in the case where no object is rendered to more than one rendering signal, that is, when at most one of the rendering gains g(k, n), k=1, . . . , K is nonzero for each n=1, . . . . , N. This is so because the quotient g²(k, n)/Σₗ₌₁^{K}g²(l, n) becomes an indicator function for object number n to belong to rendering signal k. All these objects will then be modified by the common gain f(k). In the general case, the distribution of the rendering signal alignment gains is localized in its action. For instance, if only a subset of the rendering signals needs to be adjusted, objects which are not present in this subset will not be modified.

It can be advantageous to limit the modification gains, for example by

$${h}_{lim} ( n ) = \{ \begin{matrix}0.51 if h ( n ) < 0.51 \\ 1. if h ( n ) > 1.00 \\ h ( n ) otherwise\end{matrix} \qquad ( 15 )$$

and apply the limited gains to the processed objects. Limiting the modification gains to not go below 0.51 and not go above 1.00 can be advantageous when the modification gains are applied to the JOC parameters in the encoder where the modified JOC parameters then have to be re-quantized.

### Post Gain Adjustment

There may be a benefit in a second processing step where the energies ∥L_{M}(k)∥² of the modified rendition are monitored, and if they are not sufficiently close to the energies ∥L(k)∥², an overall gain, gₒᵥₑᵣₐₗₗ, the same for all objects, can be applied so that the total energy of the modified rendition equals the total energy of the original rendition. Specifically, if

Σₖ₌₁^{K}∥L_{M}(k)∥²>threshold_{high} (16)

an overall gain

$${g}_{overall} = \sqrt{\frac{{threshold}_{high}}{{\sum }_{k = 1}^{K} {‖ {L}_{M} ( k ) ‖}^{2}}} \qquad ( 17 )$$

is applied to the modified objects, yielding

S_{M}′(n)=gₒᵥₑᵣₐₗₗS_{M}(n), n=1, . . . , N (18)

### Likewise, if

Σₖ₌₁^{K}∥L_{M}(k)∥²<threshold_{low} (19)

a gain

$${g}_{overall} = \sqrt{\frac{{threshold}_{low}}{{\sum }_{k = 1}^{K} {‖ {L}_{M} ( k ) ‖}^{2}}} \qquad ( 20 )$$

is applied to the modified objects.

Often the thresholds are functions of the original rendering signal energies ∥L(k)∥², for example

threshold_{low}=a∥L(k)∥² (21a)

threshold_{high}=bμL(k)∥² (21b)

with a≤1 and b≥1.

In the above monitoring of the energies of the modified rendition, and in the computation of the thresholds, the energies ∥L_{P}(k)∥² of the processed rendition can be used instead of the energies ∥L(k)∥² of the original rendition. Although it may seem non-sensical, the gain distribution method can, for some sets of objects, yield modified rendering signal energies that deviate more from the original rendering signal energies than do the processed rendering signal energies.

### Recursive Gain-Distribution

In some use cases it may be beneficial to do the above processing in a recursive fashion. The energies ∥L_{M}(k)∥² of the modified rendition can be fed back in a recursive process where these quantities are computed based on

$${f}^{′} ( k ) = \sqrt{\frac{{‖ L ( k ) ‖}^{2}}{{‖ {L}_{M} ( k ) ‖}^{2}}} , k = 1 , … , K \qquad ( 22 )$$

$${h}^{′} ( n ) = {\sum }_{k = 1}^{K} {f}^{′} ( k ) \frac{{g}^{2} ( k , n )}{{\sum }_{l = 1}^{K} {g}^{2} ( l , n )} \qquad ( 23 )$$

$${S}_{M}^{′} ( n ) = {h}^{′} ( n ) {S}_{M} ( n ) , n = 1 , … , N \qquad ( 24 )$$

$${L}_{M}^{′} = {GS}_{M}^{′} \qquad ( 25 )$$

In the next iteration, these quantities are computed

$${f}^{″} ( k ) = \sqrt{\frac{{‖ L ( k ) ‖}^{2}}{{‖ {L}_{M} ( k ) ‖}^{2}}} , k = 1 , … , K \qquad ( 26 )$$

$${h}^{″} ( n ) = {\sum }_{k = 1}^{K} {f}^{″} ( k ) \frac{{g}^{2} ( k , n )}{{\sum }_{l = 1}^{K} {g}^{2} ( l , n )} \qquad ( 27 )$$

$${S}_{M}^{″} ( n ) = {h}^{″ ( n )} {S}_{M}^{′} ( n ) , n = 1 , … , N \qquad ( 28 )$$

$${L}_{M}^{″} = {GS}_{M}^{″} \qquad ( 29 )$$

and so forth.

### Specifics to Object Encoding/Decoding

In a situation where the audio objects are encoded to be included in a bitstream, the modification gains can be computed in the encoder and conveyed to the decoder side where the playback rendering is done.

In one example, the original objects are represented by a set of downmix signals Y(m) and a set of reconstruction parameters

c(n,m), n=1, . . . , N; m=1, . . . , M (30)

and these parameters are transmitted in the bitstream to the decoder. In the decoder, the processed, or reconstructed (using source coding terminology), objects are computed based on

S_{reconstructed}(n)=S_{P}(n)=Σₘ₌₁^{M}c(n,m)Y(m), n=1, . . . , N (31)

where Y(m), m=1, M are the downmix signals that are transmitted in the bitstream alongside the reconstruction parameters. Because of inherent limitations in this representation of the original objects, the playback rendering can exhibit levels that are too high or too low. By applying the modification gains h(n) to the processed objects, such level deviations are reduced. The modification gains are applied indirectly to the processed objects by modifying the reconstruction parameters based on

c_{mod}(n,m)=h(n)c(n,m), n=1, . . . , N; m=1, . . . , M (32)

and transmitting the modified reconstruction parameters c_{M}(n, m) instead of c(n, m). The decoding then yields

S_{reconstructed}(n)=Σₘ₌₁^{M}c_{M}(n,m)Y(m)=h(n)Σₘ₌₁^{M}c(n,m)Y(m)=h(n)S_{P}(n)=S_{mod}(n) (33)

### Mismatch Between Nominal and Playback Rendering Configuration

There can be cases where the so called nominal rendering configuration used in the level analysis and level modification differs from the playback rendering configuration. For example, the playback rendering configuration on the decoder side may not be known at the time of encoding.

In many practical cases, for practically relevant rendering configurations (for example, 5.1.2, 5.1.4, 7.1.4, 9.1.6), the methods presented here are robust to differences in rendering configurations. Computing the modification gains with a 7.1.4 nominal rendering configuration provides robust level adjustment also for 5.1.2, 5.1.4 and 9.1.6 rendering configurations.

It can be beneficial to compute modification gains for several nominal rendering configurations

hⱼ(n), j=1, . . . , J (34)

As an example, for J=4, these rendering configurations can be for example 5.1.2, 5.1.4, 7.1.4, 9.1.6, and h₁(n), n=1, N are the modification gains associated with a 5.1.2 rendering configuration, h₂(n), n=1, . . . , N are the modification gains associated with a 5.1.4 etc. A common set of modification gains h(n), n=1, . . . , N can be computed by combining these sets of gains. The combination can be calculated like for example by a weighted sum

h(n)=Σⱼ₌₁^{J}wⱼhⱼ(n), n=1, . . . , N (35)

where Σⱼ₌₁^{j}wⱼ=1.

In cases of a mismatch between the nominal and playback rendering configuration where the averaging method does not work, the modification gains can be stored/transmitted alongside the processed objects or reconstruction parameters. If the playback rendering configuration matches any of the stored nominal configurations, the corresponding modification gains can be applied “just-in-time”. If there is still a mismatch, the “closest” nominal configuration can be used, or an averaging of nominal configurations can be used.

### Practical Implementations

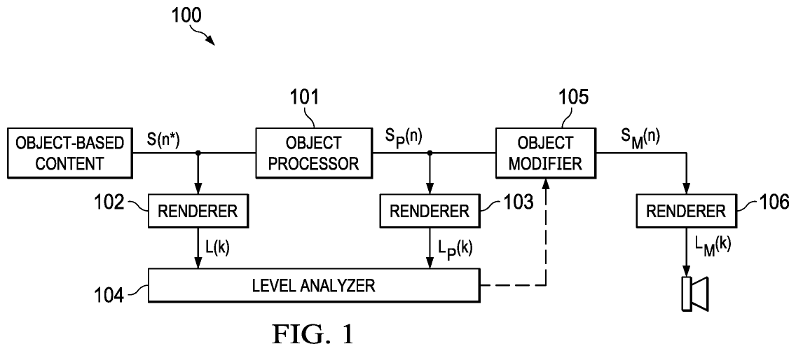

FIG. 1 illustrates an audio system 100 including an object processor 101 that takes as set of N* original objects S(n*) as input and generates a set of N processed (e.g. spatially encoded or decoded and reconstructed) objects S_{P}(n) as output.

Using the object metadata (not separately shown) the N* original objects S(n*) and the N processed objects S_{P}(n) can be rendered by two renderers 102, 103 to a nominal playback configuration (e.g. 7.1.4), resulting in the rendered representations L(k) and L_{P}(k), respectively. By analyzing and comparing the levels of both rendered representations in a level analyzer 104, it is possible to derive information to control an object modifier 105 that takes the processed objects S_{P}(n) as input and generates modified objects S_{M}(n) as output. A renderer 106 renders the modified objects to provide a rendered presentation L_{M}(k). The goal of the object modification is to make the rendered representation L_{M}(k) of the modified objects S_{M}(n) to be more similar to the rendered representation L(k) of the original objects S(n), mitigating any errors, such as level errors, introduced by the object processor 101 and observed for the rendered representation L_{P}(k) of the processed objects S_{P}(n).

In the case where the object processor is a spatial coder, the processed objects will be fewer (N*>N). In a typical spatial coding process, 128 audio objects are clustered into 20 audio objects (N*=128, N=20).

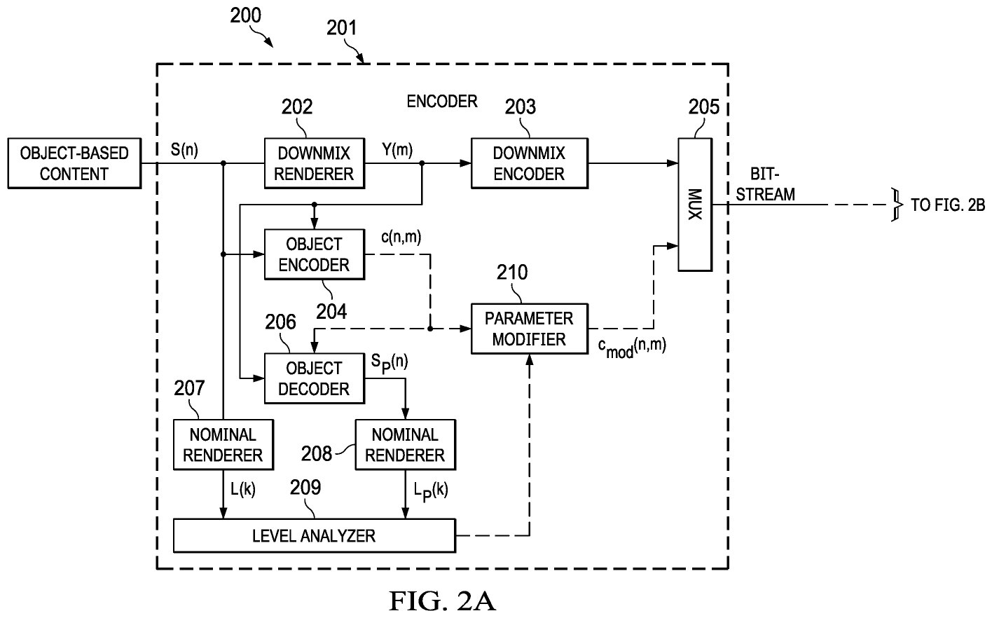

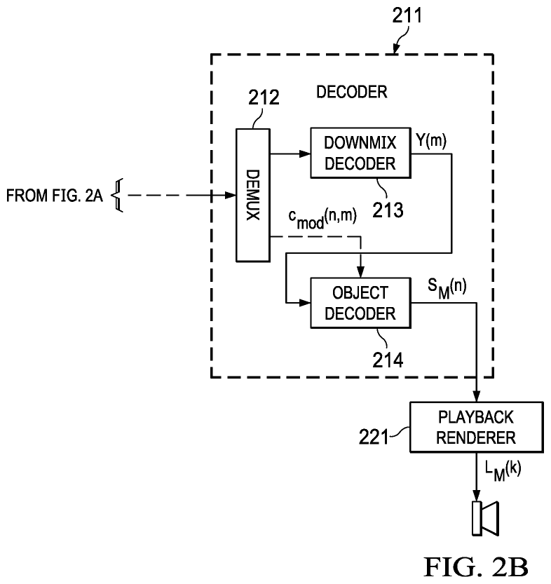

The object processor 101 in FIG. 1 may also be a combination of an encoder and a decoder, occurring in a codec process. In this case N*=N. FIGS. 2a-b illustrate how the principles of the present invention may be implemented in an exemplary encoding and decoding (codec) process 200. The codec may for example be based on a Dolby Digital Plus (DD+) codec with Joint Object Coding (JOC). It may also be based on an AC-4 codec with Advanced Joint Object Coding (A-JOC), in which case contributions from decorrelated versions of the downmix signals are also taken into consideration. An A-JOC encoder may alternatively use a downmix generated by a spatial coder instead of by a downmix renderer.

The encoder side 201 (FIG. 2a) comprises a downmix renderer 202, a downmix encoder 203, an object encoder 204, and a multiplexer 205. In one example, the blocks 202, 203, 204, 205 are substantially equivalent to corresponding blocks in a DD+JOC encoder.

In the illustrated example, the encoder 201 further comprises an object decoder 206 (e.g. a JOC decoder) and two renderers 207, 208. The object decoder is configured to decode a downmix Y(m) from the downmix renderer 202, using object reconstruction parameters c(n,m) from the object encoder 204, in order to generate processed objects S_{P}(n). The renderers 207, 208 are configured to receive the original objects S(n) and the processed objects S_{P}(n), respectively, and to use the object metadata (not separately shown) to provide first and second rendered presentations, L(k) and L_{P}(k), using a selected playback rendering configuration, e.g. a 7.1.4 configuration. The selected rendering configuration is referred to as a “nominal” rendering configuration. A level analyzer 209 is configured to receive the rendered presentations L(k) and L_{P}(k) from each renderer 207, 208, and provide a set of parameters h(n) representing a difference between the two rendered presentations (one parameter for each object). A parameter modifier 210 is configured to receive the parameters h(n) and perform a modification of the reconstruction parameters c(n, m). The modified reconstruction parameters are referred to as c_{mod}(n, m).

The decoder side 211 (FIG. 2b) comprises a demultiplexer 212, a downmix decoder 213, and an object decoder 214. In one example, the blocks 212, 213, 214, are substantially equivalent to corresponding blocks in a DD+JOC decoder. The output from the decoder side 211 is provided to a playback renderer 221.

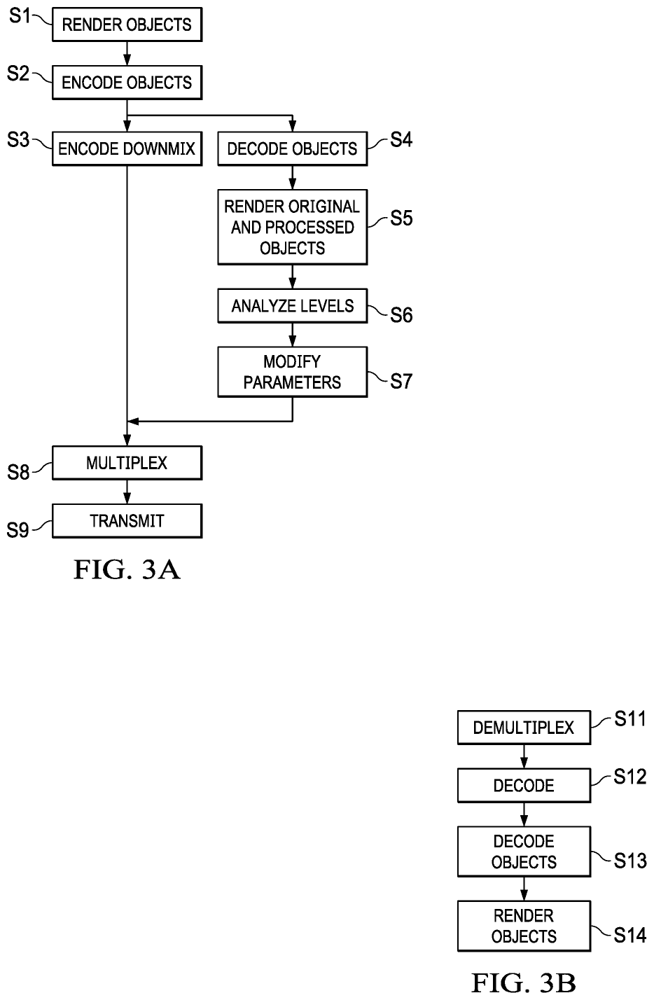

In use, and with reference to FIG. 3, a set of original objects S(n) are first (step S1) rendered in downmix renderer 202 to generate the downmix signals Y(m). In a typical encoder, a 5.1 configuration is used for the downmix, and the downmix rendering uses the object metadata (not shown). Both the original objects S(n) and the downmix signals Y(m) are used by an object encoder 204 (step S2) to compute the reconstruction parameters c(n,m). The downmix signals are also encoded (step S3) by downmix encoder 203.

In parallel with step S3, the object decoder 206 takes the downmix signals Y(m) as input and generates (step S4) the processed (i.e., reconstructed) objects S_{P}(n). Then both the original objects S(n) and the processed objects S_{P}(n) are rendered (step S5) to obtain the first and second rendered representations L(k) and L_{P}(k), respectively. Both rendered representations are then analyzed (step S6) to calculate a set of parameters h(n), referred to as object modification gains. In step S7, the parameter modifier 210 applies the object modification gains h(n) to the reconstruction parameters c(n,m) and generates modified reconstruction parameters c_{mod}(n, m).

In step S8, the encoded downmix is combined with the modified reconstruction parameters c_{mod}(n, m) and the object metadata (not shown) in a multiplexer to form the final bitstream. This bitstream is then transmitted to the decoder 211 (step S9).

On the decoder side the bitstream is demultiplexed by the demultiplexer 212 (step S11), and the downmix is decoded by downmix decoder 213 (step S12) to obtain the downmix signals Y(m). These downmix signals Y(m) are processed (step S13) by the object decoder 214, using the modified reconstruction parameters c_{mod}(n, m), to generate modified objects S_{M}(n).

Finally, the modified objects S_{M}(n) are rendered (step S14) to a representation L_{M}(k) for the desired playback configuration (e.g. a 7.1.4 loudspeaker playback) in the playback renderer 221, which uses the object metadata (not shown) conveyed in the bitstream.

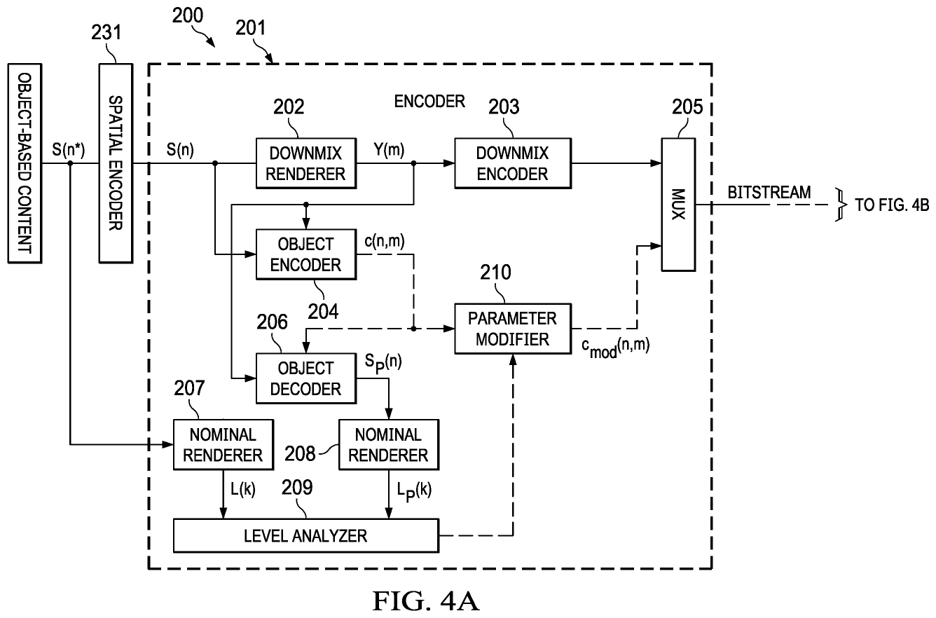

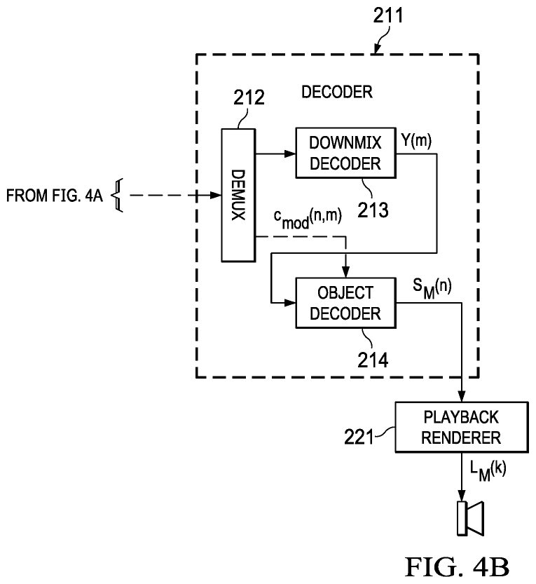

Turning to FIG. 4a-b, the encoding side (FIG. 4a) also includes a spatial coder 231, configured to perform a reduction (clustering) of an original set of N* audio objects. In a typical example, 128 original audio objects are spatially coded into 20 objects before being provided to the object encoder process. In the illustrated case, as an alternative to the process in FIG. 2a-b, the original audio objects S(n*) (e.g. 128 objects) are used by the renderer 207 to obtain the first rendition L(k).

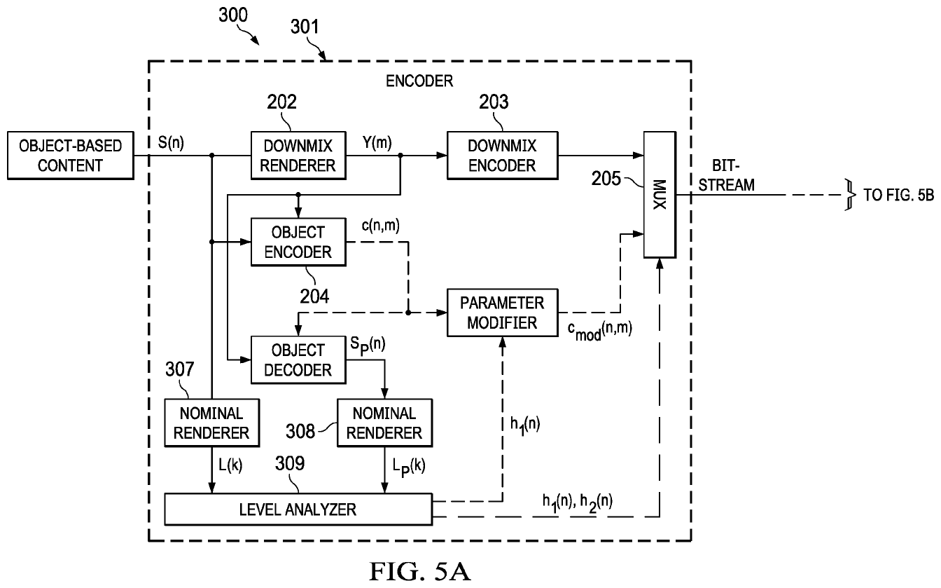

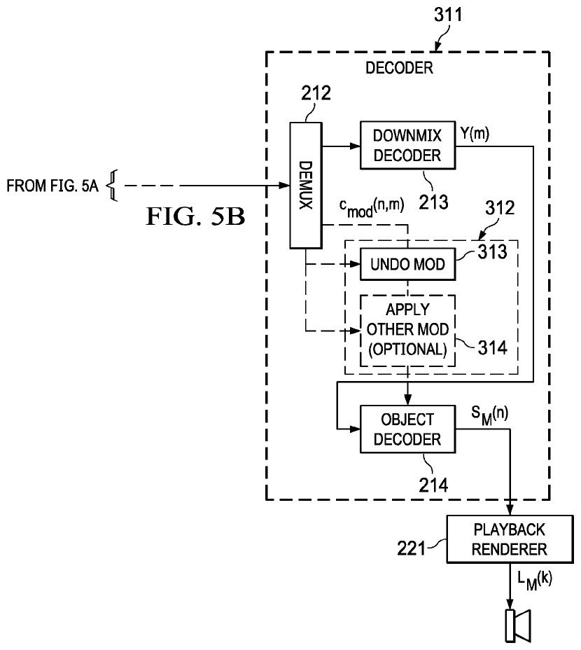

FIG. 5a-b shows yet another implementation of the present invention, where multiple sets of object specific modification gains h₁(n), h₂(n) are determined, and a set of alteration parameters based on these multiple sets of modification gains are made available to the decoder side. In the illustrated examples there are only two sets of object specific modification gains, but there may of course be any number.

In this implementation, the renderers 307, 308 on the encoder side 301 (FIG. 5a) are configured to perform multiple renditions, associated with multiple rendering configurations. In the illustrated case, two renditions are provided. They could be associated with e.g. a 7.1.4 configuration and a 9.1.6 configuration. The level analyzer 309 will make a level analysis for each pair of renditions, resulting in two sets of object specific modification gains, h₁(n) and h₂(n). One of the gain sets is used by the parameter modifier to modify the reconstruction parameters c(n, m). In addition to the encoded downmix Y(m) and the modified reconstruction parameters, the multiplexer 205 is here provided also with a set of alteration parameters based on the two sets of modification gains, h₁(n) and h₂(n), so that these alteration parameters are also included in the bitstream.

The decoder 311 (FIG. 5b) includes elements similar to the decoder 211 in FIGS. 2b and 4b. These elements have been given identical reference numerals (212, 213, 214, 221) in FIG. 5b. The decoder 311 also includes an alternation block 312, configured to apply the alteration parameters to the original reconstruction parameters, in order to obtain an alternative set of modified reconstruction parameters. This alternative set of modified reconstruction parameters may correspond to the second rendering configuration. The operation of the alternation block 312 is optional, and controlled by appropriate logic. For example, activation of the alternation block 312 can be based on a determination of the configuration of the playback renderer 221.

In a first example, illustrated in FIG. 5b, the alteration parameters include the two sets of object specific modification gains, h₁(n) and h₂(n). In this case the alternation block 312 includes two units:
1) an undo unit 313, configured to apply (an inverse of) the first set of gains h₁(n) in order to return the reconstruction parameters to their original “unmodified” state, and
2) a gain application unit 314, configured to apply the second set of gains h₂(n) to the “unmodified” reconstruction parameters, in order to obtain an alternative set of modified reconstruction parameters, here corresponding to the second rendering configuration.

It is clear that the implementation in FIG. 5B provides three different object decoding options:
1) using modified reconstruction parameters c_{mod}(n,m), providing reconstructed objects modified for improved rendering with the first rendering configuration,
2) using the alternative modified reconstruction parameters, providing reconstructed objects modified for improved rendering with the second rendering configuration, and
3) using the “unmodified” reconstruction parameters, providing the reconstrued objects without modification.

In another example, the alteration parameters include ratios h₂(n)/h₁(n) between the second and first sets of object specific modification gains h₂(n) and h₁(n). In this case, on the decoder side, these ratios may be applied to the modified reconstruction parameters corresponding to the first rendering configuration, to effect a conversion into alternative modified reconstruction parameters corresponding to the second rendering configuration.

In this case, there will be two alternative decoding options available on the decoder side:
1) using modified reconstruction parameters c_{mod}(n, m), providing reconstructed objects modified for improved rendering with the first rendering configuration, and
2) using the alternative modified reconstruction parameters, providing reconstructed objects modified for improved rendering with the second rendering configuration.

However, a special case of this particular example is that the second set of modification gains h₂(n) can be set to corresponds to unity gain, i.e. no modification of the reconstruction parameters. In other words, the alteration parameters in the bitstream become 1/h₁(n). On the decoder side, an application of these gains will then lead to a cancellation of the modification gains h₁(n), and thus provide the original “unmodified” reconstruction parameters.

The methods and systems described herein may be implemented as software, firmware and/or hardware. Certain components may be implemented as software running on a digital signal processor or microprocessor. Other components may be implemented as hardware and or as application specific integrated circuits. The signals encountered in the described methods and systems may be stored on media such as random access memory or optical storage media. They may be transferred via networks, such as radio networks, satellite networks, wireless networks or wireline networks, e.g. the Internet. Typical devices making use of the methods and systems described herein are portable electronic devices or other consumer equipment which are used to store and/or render audio signals.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention. Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary to instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the invention. In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described specific embodiments of the invention, those skilled in the art will recognize that other and further modifications may be made thereto without departing from the spirit of the invention, and it is intended to claim all such changes and modifications as falling within the scope of the invention. For example, other object encoding/decoding techniques may be implemented.

The invention includes the following enumerated exemplary embodiments (EEEs):

EEE1. A method of aligning levels of an original and processed rendition, the method comprising:

receiving a set of original objects;
receiving a set of processed objects;
receiving a rendering configuration, wherein the rendering configuration describes the mapping from the set of original objects to a set of original rendering signals, and wherein the rendering configuration also describes the mapping from the set of processed objects to a set of processed rendering signals; and
aligning of the levels of the set of processed rendering signals to the levels of the set of original rendering signals by modifying the set of processed audio objects.

EEE2. The method of EEE1, further comprising:

computing levels of the set of original rendering signals; and
compute levels of the set of processed rendering signals.

EEE3. The method of EEE1, further comprising:
rendering the set of original objects to a set of original rendering signals;
   rendering the set of processed objects to a set of processed rendering signals;
   measuring levels of the set of original rendering signals; and
   measuring levels of the set of processed rendering signals.

EEE4. The method of EEE1, wherein the aligning of levels comprises:

for each object, computing an object modification gain, and applying the object modification gain to said object.

EEE5. A method of aligning levels of rendering signals, the method comprising:

receiving a set of original objects;
receiving a set of processed objects;
receiving a rendering configuration, wherein the rendering configuration describes the
mapping from the set of original objects to a set of original rendering signals; and wherein the rendering configuration also describes the mapping from the set of processed objects to a set of processed rendering signals;
calculating a set of optimal object modification gains.

EEE6. A method of aligning levels of rendering signals, the method comprising:

receiving a set of original objects;
receiving a set of processed objects;
receiving a rendering configuration, wherein the rendering configuration describes the mapping from the set of original objects to a set of original rendering signals, wherein the rendering configuration further describes the mapping from the set of processed objects to a set of processed rendering signals;
calculating levels of the set of original rendering signals;
calculating levels of the set of processed rendering signals;
calculating a set of rendering signal correction gains;
a distribution of the set of rendering signal alignment gains to a set of object modification gains.

EEE7. The method of EEE6, wherein the mapping of the set of rendering signal alignment gains to the set of object modification gains comprises:

calculating each object modification gain as a weighted sum of the rendering signal alignment gains.

EEE8. The method of EEE7, wherein the weights in the weighted sum are a function of the rendering gains.

EEE9. The method of EEE6, wherein the modifications gains are applied to the processed objects, yielding modified objects.

EEE10. The method of EEE9, further comprising:

rendering the modified objects to a set of modified rendering signals;
calculating a total modified level of the modified rendering signals;
calculating a total reference level of a set of reference rendering signals;
calculate a total modification gain from the total modified level and the total reference level.

EEE11. The method of EEE9, further comprising:

replacing the processed objects with the modified objects and repeating the procedure.

EEE12. The method of any of EEEs 4-11, wherein the object modification gains are applied to at least a set of audio object reconstruction parameters, e.g., a set of JOC parameters.

EEE13. The method of any of EEEs 4-11, wherein the object modification gains are computed in an encoder; and

the object modifications gains are applied to at least a set of audio object reconstruction parameters, e.g., a set of JOC parameters, in the encoder, yielding modified JOC parameters; and
the modified audio object reconstruction parameters replace the at least a set of audio object reconstruction parameters in an encoder bitstream.

EEE14. The method of any of EEEs 4-13, wherein a plurality of sets of object modification gains are calculated for a plurality of rendering configurations;

a set of total object modification gains are computed by combining the plurality of sets of object modification gains

EEE15. The method of EEE14, wherein the combining is done by a weighted average of sets of object modification gains.

EEE16. The method of any of EEEs 4-15, wherein a plurality of sets of object modification gains are calculated for a plurality of rendering configurations;

the plurality of sets of object modification gains are stored with the processed objects;
a best matching set of object modification gains is applied prior to playback rendering.

EEE17. A method for decoding an encoded audio bitstream, comprising:
decoding the encoded audio bitstream to obtain a plurality of decoded audio signals, wherein the plurality of decoded audio signals comprise a multi-channel downmix of a plurality of audio object signals;
extracting from the encoded audio bitstream a plurality of sets of audio object reconstruction parameters, each set of audio object reconstruction parameters corresponding to a different channel configuration;
determining a playback rendering configuration;
determining a set of audio object reconstruction parameters from the plurality of sets of audio object reconstruction parameters based on the determined playback rendering configuration; and
applying the determined set of audio object reconstruction parameters to the plurality of decoded audio signals to obtain a reconstruction of the plurality of audio object signals.

EEE18. The method of EEE17, wherein, the determined set of audio object reconstruction parameters is the set of audio object reconstruction parameters corresponding to the determined playback rendering configuration.

EEE19. The method of EEE17, wherein, if none of the sets of the audio object reconstruction parameters correspond to a channel configuration that matches the determined playback rendering configuration, the determined set of audio object reconstruction parameters corresponds to the closest channel configuration to the determined playback rendering configuration.

EEE20. The method of EEE17, wherein, if none of the sets of the audio object reconstruction parameters match the determined playback rendering configuration, the determined set of audio object reconstruction parameters corresponds to an average of the sets of audio object reconstruction parameters.

EEE21. The method of EEE20, wherein the average is a weighted average.

EEE22. The method of any one of EEEs 17-21, further comprising extracting object metadata from the encoded bitstream, and rendering the reconstruction of the plurality of audio object signals to the determined playback rendering configuration in response to the object metadata.

EEE23. A method for decoding an encoded audio bitstream, comprising:
decoding the encoded audio bitstream to obtain a plurality of decoded audio signals, wherein the plurality of decoded audio signals comprise a multi-channel downmix of a plurality of audio object signals;
extracting from the encoded audio bitstream a set of audio object reconstruction parameters;
applying the set of audio object reconstruction parameters to the plurality of decoded audio signals to obtain a reconstruction of the plurality of audio object signals;
wherein the plurality of reconstruction parameters were computed according to the method of EEE13.

EEE24. The method of EEE23, further comprising extracting object metadata from the encoded bitstream, and rendering the reconstruction of the plurality of audio object signals to a playback rendering configuration in response to the object metadata.

1. A method for modifying object reconstruction information, comprising:
obtaining a set of N spatial audio objects, each spatial audio object including an audio signal and spatial metadata;
obtaining an audio presentation representing said N spatial audio objects;
obtaining object reconstruction information configured to reconstruct said N spatial audio objects from said audio presentation;
applying said reconstruction information to said audio presentation to form a set of N reconstructed spatial audio objects;
using a first rendering configuration, rendering the N spatial audio objects to obtain a first rendered presentation, and rendering the N reconstructed spatial audio objects to obtain a second rendered presentation; and
modifying the reconstruction information based on a difference between the first rendered presentation and the second rendered presentation, thereby forming modified reconstruction information.

2. The method according to claim 1, wherein the set of N spatial audio objects have been obtained by spatially coding a set of L spatial audio objects, wherein L>N, and wherein said first rendered presentation is obtained by rendering the L spatial audio objects.

3. The method according to claim 1, wherein said audio presentation is a set of M audio signals, and further comprising:
encoding the M audio signals into a set of encoded audio signals; and
combining said encoded audio signals and said modified reconstruction information into a bitstream for transmission.

4. The method according to claim 3, wherein the M audio signals represent a downmix of the audio signals of said N spatial audio objects, the object reconstruction information is a set of reconstruction parameters, c(n, m), configured to reconstruct said N spatial audio objects from said M audio signals, and the modified reconstruction information is a set of modified reconstruction parameters, c_{mod}(n, m).

5. The method according to claim 4, wherein the modifying step includes determining a set of object specific modification gains, h₁(n), associated with the first rendering configuration, and where the object specific modification gains h₁(n) are applied to the set of object reconstruction parameters c(n, m).

6. The method according to claim 5, wherein the object specific modification gains h₁(n) are determined by:
determining first levels of the first rendered presentation;
determining second levels of the second rendered presentation;
calculating a set of level alignment gains based on a difference between the first and second levels; and
forming the object specific modification gains h₁(n) as a linear combination of the level alignment gains.

7. The method according to claim 6, further comprising calculating each object specific modification gain h₁(n) as a weighted sum of the level alignment gains, and wherein the weights in the weighted sum are optionally a function of rendering gains used to generate the first and second rendered presentations.

8. The method according to claim 5, further comprising:
using a second rendering configuration, rendering the N spatial audio objects to generate a third rendered presentation and rendering the N reconstructed spatial audio objects to generate a fourth rendered presentation;
determining a second set of object specific modification gains, h₂(n), associated with the second rendering configuration; and
including, in the encoded bitstream, one of:
1) both the first and second set of object specific modification gains, h₁(n) and h₂(n) and
2) a ratio between the second and first set of object specific modification gains, h₂(n)/h₁(n).

9. A decoding method for decoding spatial audio objects in a bitstream, comprising:
decoding the bitstream to obtain:
a set of M audio channels,
a set of reconstruction parameters, c_{mod}(n, m), configured to reconstruct a set of N spatial audio objects from said M audio signals, said reconstruction parameters associated with a first rendering configuration, and
alteration parameters associated with a second rendering configuration;
determining a playback rendering configuration;
in response to determining said playback rendering configuration, applying said alteration parameters to said reconstruction parameters, c_{mod}(n, m), to obtain alternative reconstruction parameters c_{mod2}(n, m); and
applying said alternative reconstruction parameters c_{mod2}(n, m) to said M audio signals to obtain a set of N reconstructed spatial audio objects.

10. The decoding method according to claim 9, wherein the playback rendering configuration is determined to correspond to said second rendering configuration, and wherein the alteration parameters are applied so that the alternative reconstruction parameters c_{mod2}(n, m) are associated with the second rendering configuration.

11. The decoding method according to claim 9, wherein the alteration parameters are applied partially, so that the alternative reconstruction parameters c_{mod2}(n, m) correspond to a weighted average of the set of reconstruction parameters, c_{mod}(n, m), and the set of reconstruction parameters, c_{mod}(n, m), after application of the alteration parameters.

12. The decoding method according to claim 9, wherein the alteration parameters include a set of ratios, h₂(n)/h₁(n), between second object specific modification gains, h₂(n), associated with the second rendering configuration and first object specific modification gain, h₁(n), associated with the first rendering configuration.

13. The decoding method according to claim 9,
wherein the alteration parameters include a first set of object specific modification gains, h₁(n), associated with the first rendering configuration and a second set of object specific modification gains h₂(n), associated with the second rendering configuration, and
wherein said step of applying the alteration parameters to the reconstruction parameters includes:
applying the first set of modification gains to remove the reconstruction parameter's association with the first rendering configuration, and
applying the second set of modification gains to associate the reconstruction parameters to the second rendering configuration.

14. An encoder comprising:
a downmix renderer configured to receive a set of N spatial audio objects and to generate a set of M audio signals representing said N spatial audio objects;
an object encoder for obtaining object reconstruction information configured to reconstruct said N spatial audio objects from said M audio signals;
an object decoder for applying said reconstruction information to said M audio signals to form a set of N reconstructed spatial audio objects;
a renderer configured to, using a first rendering configuration, render the N spatial audio objects to obtain a first rendered presentation and render the N reconstructed spatial audio objects to obtain a second rendered presentation;
a modifier for modifying the reconstruction information based on a difference between the first rendered presentation and the second rendered presentation, thereby forming modified reconstruction information;
an encoder configured to encode the M audio signals into a set of encoded audio signals; and
a multiplexer for combining said encoded audio signals and said modified reconstruction information into a bitstream for transmission.

15. A decoder comprising:
a decoder for decoding a bitstream including:
a set of M audio channels,
a set of reconstruction parameters, c_{mod}(n, m), configured to reconstruct a set of N spatial audio objects from said M audio signals, said reconstruction parameters associated with a first rendering configuration, and
modification gains associated with a second rendering configuration;
an alternation unit configured to, in response to a determined playback rendering configuration, apply said modification gains to said reconstruction parameters, c_{mod}(n, m), to obtain alternative reconstruction parameters c_{mod2}(n, m); and
an object decoder for applying said alternative reconstruction parameters c_{mod2}(n, m) to said M audio signals to obtain a set of N reconstructed spatial audio objects.

16. A non-transitory computer media containing instructions configured to perform the method according to claim 1 when executed on a computer processor.

17. A non-transitory computer media containing instructions configured to perform the method according to claim 9 when executed on a computer processor.
